(19) United States
(12) Patent Application Publication
(10) Pub. No.: US 2007/0013674 A1
(43) Pub. Date: Jan. 18, 2007

(54) RECTANGULAR SENSOR GRID THAT PROVIDES FUNCTIONALITY AS A RECTANGULAR TOUCHPAD SENSOR AND A CIRCULAR SCROLLING REGION

(76) Inventor: Richard D. Woolley, Orem, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/457,096

(22) Filed: Jul. 12, 2006

Related U.S. Application Data
(60) Provisional application No. 60/698,392, filed on Jul. 12, 2005.

(51) Int. Cl. G09G 5/00

(52) U.S. Cl. 345/173

(57) ABSTRACT

A touchpad that provides general-purpose touchpad functionality such as cursor control controlled by movement of a pointing object on a touchpad surface, wherein a mode of operation of the touchpad can be changed such that the touchpad now provides functionality through a circular scrolling region defined as a circular region on the touchpad surface, to thereby provide improved manipulation of lists and other functions that can be provided by a circular scrolling region.

### CROSS REFERENCE TO RELATED APPLICATIONS

This document claims priority to, and incorporates by reference all of the subject matter included in the provisional patent application docket number 3339.CIRQ.PR, having Ser. No. 60/698,392 and filed on Jul. 12, 2005.

### BACKGROUND OF THE INVENTION

1. Field of the Invention

This invention relates generally to touchpads. More specifically, a capacitance sensitive touchpad providing cursor control and having a rectangular shape as defined by electrodes forming an X-Y grid, can also provide a circular scrolling region that enables circular movements across the circular scrolling region to cause scrolling through a displayed list.

2. Description of Related Art

The state of the art in capacitance sensitive touchpads is characterized by the touchpad and touchpad sensor circuits of Cirque™ Corporation. Cirque® Corporation touchpad technology has evolved, but several elements of the past and present hardware and testing methodology can be used to demonstrate the present invention.

From a hardware perspective as shown in FIG. 1, a capacitance sensitive touchpad 10 as taught by Cirque® Corporation includes a grid of row 12 and column 14 (or X and Y) electrodes in a touchpad electrode grid. These grids are separated by some material, and are often simply different layers as shown here. Alternatively, the electrode grids are printed on opposite sides of a suitable substrate material. All measurements of touchpad parameters are taken from a single sense electrode 16 also disposed around or interspersed among the electrodes 12 and 14 of touchpad 10, and not from the X or Y electrodes themselves. In addition, no fixed reference point is used for measurements. This is an advantageous feature of a mutual capacitance touchpad that determines the change in capacitance on the sense line.

A touchpad sensor circuit 20 generates signals from P,N generators 22, 24 that are sent directly to the X and Y electrodes 12, 14 in various patterns. Accordingly, there is a one-to-one correspondence between the number of electrodes on the touchpad electrode grid, and the number of drive pins on the touch sensor circuitry 20.

A touchpad sensor circuit generates signals that are sent directly to the X and Y electrodes in various patterns. Accordingly, there is a one-to-one correspondence between the number of electrodes on the touchpad electrode grid, and the number of drive pins on the touch sensor circuit.

The touchpad 10 does not depend upon an absolute capacitive measurement to determine the location of a finger (or other capacitive object) on the touchpad surface. The touchpad 10 measures an imbalance in electrical charge to the sense line 16. When no pointing object is on the touchpad 10, the touchpad circuitry 20 is in a balanced state, and there is no signal on the sense line 16. There may or may not be a capacitive charge on the electrodes 12, 14. In the methodology of Cirque® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance of electrical charge on the sense line.

The touchpad 10 must make two complete measurement cycles for the X electrodes and for the Y electrodes (four complete measurements) in order to determine the position of a finger. The steps are as follows for both the X and the Y electrodes:

First, a group of electrodes (say a select group of the X electrodes 12) are driven with a first signal from P,N generator 22 and a first measurement using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined.

Accordingly, the touchpad 10 measures a change in capacitance in order to determine the location of a finger. All of this hardware and the methodology described above assume that the touch sensor circuit 20 is directly driving the electrodes 12, 14 of the touchpad 10. Thus, for a typical 12×16 electrode grid touchpad, there are a total of 28 pins (12+16=28) available from the touch sensor circuitry 20 that are used to drive the electrodes 12, 14 of the electrode grid.

Accordingly, the touchpad measures a change in capacitance in order to determine the location of a finger. All of this hardware and the methodology described above assume that the touch sensor circuit is directly driving the electrodes of the touchpad 10. Thus, for a typical 12×16 electrode grid touchpad, there are 28 pins on the touch sensor circuit that are used to drive the electrodes 12, 14. Smaller touchpads that use fewer electrodes are also provided by Cirque® Corporation, such as a 6×8 electrode grid used in many portable electronic devices, such as mobile telephones.

The general purpose touchpad as described above is typically used for touchpad functions such as cursor control, scrolling through lists, navigation through web pages, etc. Regarding scrolling, a vertical and/or horizontal scrolling region is typically disposed on an edge of the rectangular touchpad.

The proliferation of portable electronic appliances has created a demand for innovative interfaces that allow users to more easily control such appliances. For example, some MP3 music devices provide a dedicated circular scrolling region that enables navigation through lists of music, artists, options, settings, etc.

It would be an advantage over the state of the art in touchpads to provide general purpose functionality that can be provided by a rectangular touchpad, combined with the functionality of a circular scrolling region for rapid movement through lists, but all disposed on a rectangular touchpad surface.

### BRIEF SUMMARY OF THE INVENTION

It is an object of the present invention to provide a general purpose touchpad that provides general purpose touchpad functionality such as cursor control, and also provide specialized functionality through a circular scrolling region that enables scrolling through lists, navigation through web pages, and any other functions associated with circular scrolling regions.

In a preferred embodiment, the present invention is a touchpad that provides general-purpose touchpad functionality such as cursor control controlled by movement of a pointing object on a touchpad surface, wherein a mode of operation of the touchpad can be changed such that the touchpad now provides functionality through a circular scrolling region defined as a circular region on the touchpad surface, to thereby provide improved manipulation of lists and other functions that can be provided by a circular scrolling region.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a schematic block diagram of a prior art touch sensor circuit and an electrode grid of a capacitance sensitive touchpad.

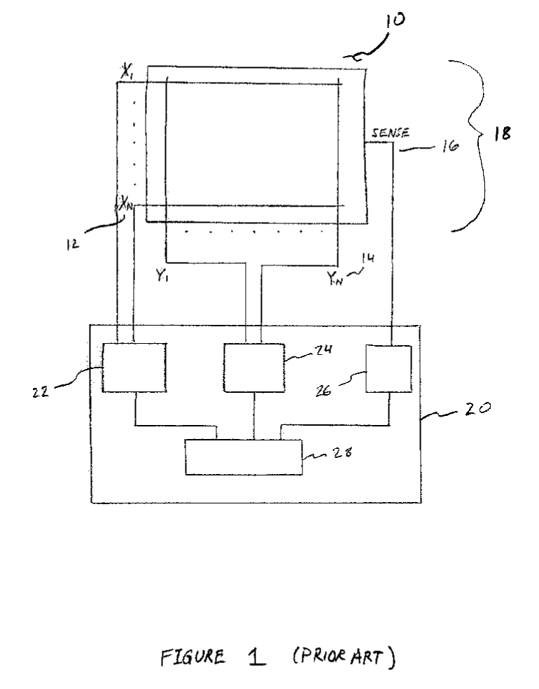

FIG. 2 is a top view of the surface of a touchpad, illustrating a first embodiment of the rectangular region defined by the electrodes, and the outline of a first circular scrolling region that can be made functional by changing the operating mode of the touchpad.

FIG. 3 is a top view of the surface of the touchpad, illustrating a second embodiment of the rectangular region defined by the electrodes, and the outline of two circular scrolling regions.

FIG. 4 is a top view of the surface of the touchpad, illustrating a third embodiment of the rectangular region defined by the electrodes, and the outline of four scrolling regions.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is a modified capacitance sensitive touchpad that is capable of performing object detection and tracking on a surface thereof. Such a touchpad is manufactured by Cirque® Corporation. As explained above, the capacitance sensitive touchpad is capable of providing functionality that is generally associated with touchpads. As an example, such functionality includes, but should not be considered to be limited to, cursor control. Controlling a cursor is generally considered to be a primary touchpad function when used with a graphical user interface. As portable electronic appliances, such as mobile telephones and MP3 players become more sophisticated and provide more functionality, the interface to such devices is also evolving.

It should also be realized that improved user interfaces are not restricted to just portable electronic appliances. Many stationary or simply larger devices are now including more sophisticated interfaces.

Accordingly, it is an embodiment of the present invention to provide a rectangular or square touchpad that provides typical touchpad functionality, such as cursor control, button input, navigation through web pages, etc. However, in addition to these “typical” touchpad functions, the present invention also provides a circular scrolling region or regions. The touchpad is modified to include control circuitry that recognizes different modes of operation. In a first mode of operation, the touchpad function as a typical touchpad. In a second mode of operation, the touchpad provides a circular region or regions where the touchpad provides dedicated scrolling capabilities.

When considering operation of the touchpad of the present invention, it is useful to look at an example where the present invention can be used. Consider a circular scrolling region that is already found on some MP3 music players. A user is able to scroll continuously up and down through lists of music, through artists, etc. by moving a finger in a circular direction. The circular motion thus enables the user to keep scrolling in a single direction without interruption. In other words, the user does not have to lift a finger from the scrolling region and reset it to a beginning position in order to continue movement in a desired direction. A circular scrolling region has no beginning or ending position, thus enabling the user to maintain movement in a desired direction without interruption. Reversing the direction of scrolling is also accomplished by simply reversing the direction of circular movement in a circular path of the scrolling region. In essence, the present invention provides typical touchpad functionality and circular scrolling functionality using the same touchpad.

One method of providing these two functions with the same hardware is to provide a mode switch. The mode switch enables a user to change back and forth between the two different functions of the touchpad. The different functionality is thus provided by two different programs, typically stored in the firmware of the touchpad circuitry, and/or in driver software. Thus, the hardware does not need to be modified to provide the desired dual-functionality of the touchpad. The touchpad hardware will function the same regardless of the mode of operation. Detection and tracking of a finger or other pointing object on the touchpad surface is the same for both functions. What will change is the information being transmitted from the touchpad circuitry to a device that is receiving input.

A control for switching between different modes of operation can be provided on or off the touchpad itself. For example, the switch might be a dedicated switch on the touchpad surface that is used exclusively for touchpad mode switching. Thus, the function of the switch would not change, regardless of the mode of operation. Alternatively, the switch could be implemented in driver software, and not be switch on the touchpad itself.

In a first mode of operation, the touchpad will send information that enables cursor control, web page navigation, button input, etc. In a second mode of operation, the touchpad will send information that enables scrolling functions, such as the direction of scrolling and the speed of scrolling. These functions should not be considered limiting. The touchpad will send whatever information is appropriate for the mode operation being used.

It is envisioned that many different devices can take advantage of the dual-functionality of the present invention. Such devices include, but should not be considered to be limited to, both portable and non-portable devices.

Portable devices may include, but should not be considered limited to, digital cameras, digital camcorders, MP3 players, multimedia devices, mobile telephones, personal digital assistants (PDAs), laptop computers, notebook computers, tablet computers, etc.

Non-portable devices may include, but should not be considered to be limited to, industrial equipment, desktop computers, controls for kitchen appliances, controls for household appliances such as washers and dryers, controls for electronic equipment in the home, including entertainment devices such as stereos, DVD players, receivers, home entertainment centers, and controls for automobiles and other vehicles, etc.

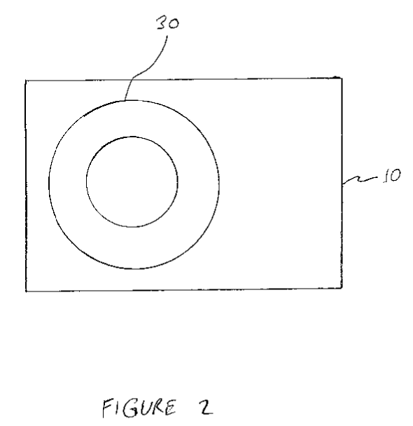

As a brief illustration of a first embodiment of the present invention, FIG. 2 is provided as a top view of the surface of a touchpad 10. This figure illustrates a rectangular touchpad defined by the X and Y electrodes 12, 14, and the outline of a single circular scrolling region 30 that can be made functional by changing the operating mode of the touchpad 10. The touchpad 10 still operates by detecting the location of a pointing object on the surface of the touchpad, but the location information is now used to control scrolling through lists, instead of providing some other touchpad functionality.

It should be observed that the “rectangular” shape of the touchpad 10 in this embodiment should not be considered limiting. The touchpad can assume other shapes, such as a square. Likewise, the “circular” scrolling region could also be formed as any other arbitrary shape. What is important in a scrolling region of the present invention is that movement should be able to follow some continuous path without interruption as long as the user desires to move the pointing object. Thus, the circular scrolling region 30 was selected because of the ease of following an uninterrupted path when performing the scrolling function. Nevertheless, other paths could be stored in the firmware. Thus, the first embodiment illustrated in FIG. 2 is for purposes of providing one example of a path, and should not be considered limiting of potential continuous paths that can be created.

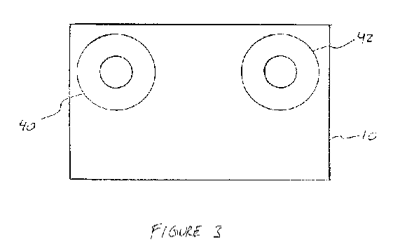

FIG. 3 is provided as a top view of the surface of the touchpad 10. This figure illustrates a rectangular touchpad defined by the X and Y electrodes 12, 14. However, this second embodiment of the invention includes first and second circular scrolling regions 40, 42. The position of the two circular scrolling regions 40, 42 is for illustration purposes only, and can be changed according to the wishes of the designer. For example, the circular scrolling regions 40, 42 might be disposed in the corners of the touchpad because they are easy to locate.

For example, the first circular scrolling region 40 can be used to control the volume of a multimedia device. The second circular scrolling region 42 can be used to control a playlist of a multimedia device.

An important observation is that the functions controlled by the scrolling regions can be dedicated, but also switchable. For example, the function being controlled by the scrolling regions is already known to the touchpad when operating in a specific mode of operation. In FIG. 3, the scrolling regions became multimedia controls. But there can be more than one of operation of the multimedia controls. For example, in a first mode, the touchpad is performing typical touchpad functions. In a second mode of operation, the touchpad 10 is controlling the multimedia functions of volume and movement through a playlist. In a third mode of operation, the first scrolling region 40 controls some other function of the multimedia device. For example, the first scrolling region may control fast forwarding and rewinding through multimedia content in the multimedia device, and the second scrolling region may control skipping of multimedia content in a forward and a reverse direction in the multimedia device.

There can be any number of modes of operation. The modes of operation are limited only by the functions that need to be available. Programming of the different modes of operation is all accomplished in firmware and/or driver software.

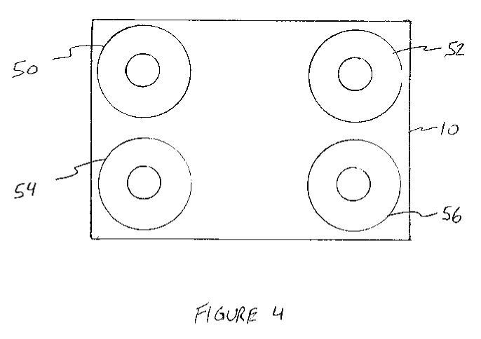

In addition, the present invention is not limited to one or two scrolling regions on touchpad 10. FIG. 4 is provided as a top view of the surface of the touchpad 10. This figure illustrates a rectangular touchpad and four scrolling regions 50, 52, 54 and 56. As in the other embodiments, these four scrolling regions 50, 52, 54, and 56 may be dedicated to a single function, or to multiple functions depending upon the mode of operation of the touchpad 10.

It should be noted that although the present invention has been described in terms of using capacitance-sensitive touchpad technology, other proximity-sensitive and touch-sensitive touchpad technology can also be used to implement the present invention. For example, the present invention may be implemented using electromagnetic, inductive, pressure sensing, electrostatic, ultrasonic, optical, resistive membrane, semi-conductive membrane or other finger or stylus-responsive technology.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for providing separate and dedicated general-purpose touchpad functions and scrolling functionality on a touchpad, said method comprising the steps of:
(1) operating in a first mode of operation, wherein the touchpad is dedicated to performing general-purpose touchpad functions that do not include scrolling;
(2) actuating a switch to cause the touchpad to begin a second mode of operation;
(3) operating in the second mode of operation, wherein the touchpad is dedicated to performing a scrolling function.

2. The method as defined in claim 1 wherein the second mode of operation further comprises the step of providing a continuous path for a pointing object on a touchpad surface in order to execute the scrolling function, wherein the user does not have to interrupt movement of the pointing object in order to perform scrolling in a desired direction.

3. The method as defined in claim 2 wherein the step of providing the continuous path further comprises the step of providing a circular path for the pointing object.

4. The method as defined in claim 2 wherein the step of providing the continuous path further comprises the steps of:
(1) providing scrolling in a first list direction by moving around the continuous path in a first path direction; and
(2) providing scrolling in a direction opposite the first list direction by moving around the continuous path in a direction that is opposite the first path direction.

5. The method as defined in claim 1 wherein the method further comprises the step of actuating the switch a second time to thereby return to the first mode of operation.

6. The method as defined in claim 1 wherein the method further comprises the steps of:
(1) providing a plurality of modes of operation;
(2) moving sequentially from one mode of operation to a next mode of operation by actuating the switch; and
(3) returning to the first mode of operation after the switch is actuated when operating in a last mode of operation.

7. The method as defined in claim 6 wherein the method further comprises the steps of:
(1) controlling a first scrolling function in a first scrolling mode of operation; and
(2) controlling a second scrolling function in a second scrolling mode of operation.

8. The method as defined in claim 1 wherein the method further comprises the step of providing a plurality of scrolling regions on the touchpad.

9. The method as defined in claim 8 wherein the method further comprises the step of dedicating different scrolling functions to each of the plurality of scrolling regions on the touchpad.

10. The method as defined in claim 9 wherein the method further comprises the step of enabling a user to assign scrolling functions to at least one of the plurality of scrolling regions on the touchpad.

11. The method as defined in claim 3 wherein the method further comprises the step of disposing an overlay on the touchpad to thereby provide a visual indication of the location of the circular path on the touchpad surface.

12. The method as defined in claim 1 wherein the step of performing the scrolling function further comprises the step of selecting the scrolling function from the group of scrolling functions comprised of scrolling through items in a list, controlling volume, moving forward in a rapid manner through audio, video, or multimedia content, moving backwards in a rapid manner through audio, video, or multimedia content, skipping forward through audio, video or multimedia content, and skipping backward through multimedia content.

13. The method as defined in claim 1 wherein the method further comprises the step of providing the touchpad with at least two modes of operation in portable electronic appliances selected from the group of portable electronic appliances comprised of digital cameras, digital camcorders, portable music players, multimedia devices, mobile telephones, personal digital assistants (PDAs), laptop computers, notebook computers, and tablet computers.

14. The method as defined in claim 1 wherein the method further comprises the step of providing the touchpad with at least two modes of operation in electronic appliances selected from the group of electronic appliances comprised of industrial equipment, desktop computers, kitchen appliances, household appliances such, electronic equipment in the home, including entertainment devices such as stereos, DVD players, receivers, home entertainment centers, and automobiles and other vehicles.

15. A touchpad that provides separate and dedicated general-purpose touchpad functions and scrolling functionality, said touchpad comprised of:
a touchpad capable of detecting a location of and tracking movement of a pointing object on a touchpad surface;
control circuitry for controlling operation of the touchpad;
software for controlling operation of the control circuitry, wherein the software includes a first mode of operation wherein the touchpad is dedicated to performing general-purpose touchpad functions that do not include scrolling, and a second mode of operation, wherein the touchpad is dedicated to performing a scrolling function; and
a switch for toggling between the first mode of operation and the second mode of operation.

16. The touchpad as defined in claim 15 wherein the touchpad is selected from the group of touchpad technologies comprised of electromagnetic, inductive, pressure sensing, electrostatic, ultrasonic, optical, resistive membrane, semi-conductive membrane or other finger or stylus-responsive technologies.

17. The touchpad as defined in claim 15 wherein the switch is further comprised of a dedicated mechanical switch.

18. The touchpad as defined in claim 17 wherein the switch is a non-mechanical switch that is controlled by the software.

19. The touchpad as defined in claim 15 wherein the touchpad is implemented in portable electronic appliances selected from the group of portable electronic appliances comprised of digital cameras, digital camcorders, portable music players, multimedia devices, mobile telephones, personal digital assistants (PDAs), laptop computers, notebook computers, and tablet computers.

20. The touchpad as defined in claim 15 wherein the touchpad is implemented in electronic appliances selected from the group of electronic appliances comprised of industrial equipment, desktop computers, kitchen appliances, household appliances such, electronic equipment in the home, including entertainment devices such as stereos, DVD players, receivers, home entertainment centers, and automobiles and other vehicles.
